(19) United States
(12) Patent Application Publication
(10) Pub. No.: US 2025/0167870 A1
(43) Pub. Date: May 22, 2025

(54) TECHNIQUES FOR USER EQUIPMENT COMPONENT EVENT BASED ANTENNA SWITCHING

(71) Applicant: QUALCOMM Incorporated, San Diego, CA (US)

(72) Inventors: Thawatt GOPAL, San Diego, CA (US); Sridhar BANDARU, Westminster, CO (US); Mihir NABAR, Hyderabad (IN)

(21) Appl. No.: 18/833,643

(22) PCT Filed: Mar. 14, 2023
(86) PCT No.: PCT/US2023/064307

§ 371 Date: Jul. 26, 2024

(30) Foreign Application Priority Data
Apr. 20, 2022 (IN) 202241023379

(51) Int. Cl. H04B 7/08

(52) U.S. Cl. CPC H04B 7/0868; H04B 7/0817

(57) ABSTRACT

Various aspects of the present disclosure generally relate to wireless communication. In some aspects, a user equipment (UE) may communicate using a first antenna and a second antenna. The UE may detect an event associated with a component of the UE. The UE may switch a radio frequency (RF) chain from the first antenna to a third antenna based on the detection of the event. The UE may measure, using the second antenna and the third antenna, one or more signals to obtain one or more measurement values based at least in part on switching the RF chain from the first antenna to the third antenna. The UE may transmit a communication using the second antenna or the third antenna based on the one or more measurement values. Numerous other aspects are described.

### CROSS-REFERENCE TO RELATED APPLICATION

This Patent Application claims priority to Indian patent application Ser. No. 202241023379, filed on Apr. 20, 2022, entitled “TECHNIQUES FOR USER EQUIPMENT COMPONENT EVENT BASED ANTENNA SWITCHING,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for user equipment (UE) component event based antenna switching.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include communicating using a first antenna and a second antenna, wherein a number of receiving radio frequency (RF) chains associated with the UE is less than a number of physical antennas, including the first antenna and the second antenna, associated with the UE. The method may include detecting an event associated with a component of the UE, wherein the event is associated with antenna switching and with the first antenna. The method may include switching an RF chain from the first antenna to a third antenna based at least in part on the detection of the event and the event being associated with the first antenna. The method may include measuring, using the second antenna and the third antenna, one or more signals to obtain one or more measurement values based at least in part on switching the RF chain from the first antenna to the third antenna. The method may include transmitting a communication using the second antenna or the third antenna based at least in part on the one or more measurement values.

Some aspects described herein relate to a UE for wireless communication. The user equipment may include a memory and one or more processors coupled to the memory. The one or more processors may be configured to communicate using a first antenna and a second antenna, wherein a number of receiving RF chains associated with the UE is less than a number of physical antennas, including the first antenna and the second antenna, associated with the UE. The one or more processors may be configured to detect an event associated with a component of the UE, wherein the event is associated with antenna switching and with the first antenna. The one or more processors may be configured to switch an RF chain from the first antenna to a third antenna based at least in part on the detection of the event and the event being associated with the first antenna. The one or more processors may be configured to measure, using the second antenna and the third antenna, one or more signals to obtain one or more measurement values based at least in part on switching the RF chain from the first antenna to the third antenna. The one or more processors may be configured to transmit a communication using the second antenna or the third antenna based at least in part on the one or more measurement values.

Some aspects described herein relate to a non-transitory computer-readable medium that stores a set of instructions for wireless communication by UE. The set of instructions, when executed by one or more processors of the UE, may cause the UE to communicate using a first antenna and a second antenna, wherein a number of receiving RF chains associated with the UE is less than a number of physical antennas, including the first antenna and the second antenna, associated with the UE. The set of instructions, when executed by one or more processors of the UE, may cause the UE to detect an event associated with a component of the UE, wherein the event is associated with antenna switching and with the first antenna. The set of instructions, when executed by one or more processors of the UE, may cause the UE to switch an RF chain from the first antenna to a third antenna based at least in part on the detection of the event and the event being associated with the first antenna. The set of instructions, when executed by one or more processors of the UE, may cause the UE to measure, using the second antenna and the third antenna, one or more signals to obtain one or more measurement values based at least in part on switching the RF chain from the first antenna to the third antenna. The set of instructions, when executed by one or more processors of the UE, may cause the UE to transmit a communication using the second antenna or the third antenna based at least in part on the one or more measurement values.

Some aspects described herein relate to an apparatus for wireless communication. The apparatus may include means for communicating using a first antenna and a second antenna, wherein a number of receiving RF chains associated with the apparatus is less than a number of physical antennas, including the first antenna and the second antenna, associated with the apparatus. The apparatus may include means for detecting an event associated with a component of the apparatus, wherein the event is associated with antenna switching and with the first antenna. The apparatus may include means for switching an RF chain from the first antenna to a third antenna based at least in part on the detection of the event and the event being associated with the first antenna. The apparatus may include means for measuring, using the second antenna and the third antenna, one or more signals to obtain one or more measurement values based at least in part on switching the RF chain from the first antenna to the third antenna. The apparatus may include means for transmitting a communication using the second antenna or the third antenna based at least in part on the one or more measurement values.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in

detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of antenna ports, in accordance with the present disclosure.

FIG. 4 is a diagram illustrating an example of a transmit (Tx) chain and a receive (Rx) chain of a UE, in accordance with the present disclosure.

FIG. 5 is a diagram illustrating an example of a radio frequency (RF) front end architecture of a UE, in accordance with the present disclosure.

FIGS. 6A-6G are diagrams illustrating an example associated with UE component event-based antenna switching, in accordance with the present disclosure.

FIG. 7 is a diagram illustrating an example process performed, for example, by a UE, in accordance with the present disclosure.

FIG. 8 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

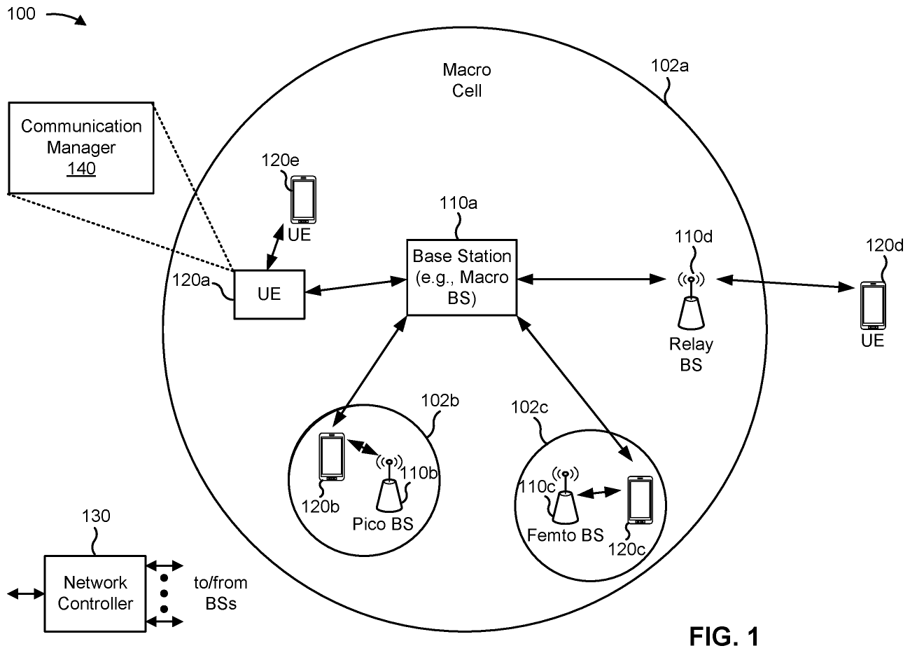

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may communicate using a first antenna and a second antenna, wherein a number of receiving radio frequency (RF) chains associated with the UE is less than a number of physical antennas, including the first antenna and the second antenna, associated with the UE; detect an event associated with a component of the UE, wherein the event is associated with antenna switching and with the first antenna; switch an RF chain from the first antenna to a third antenna based at least in part on the detection of the event and the event being associated with the first antenna; measure, using the second antenna and the third antenna, one or more signals to obtain one or more measurement values based at least in part on switching the RF chain from the first antenna to the third antenna; and transmit a communication using the second antenna or the third antenna based at least in part on the one or more measurement values. Additionally, or alternatively, the communication manager 140 may perform one or more other operations described herein.

As indicated above, FIG. 1 is provided as an example. Other examples may differ from what is described with regard to FIG. 1.

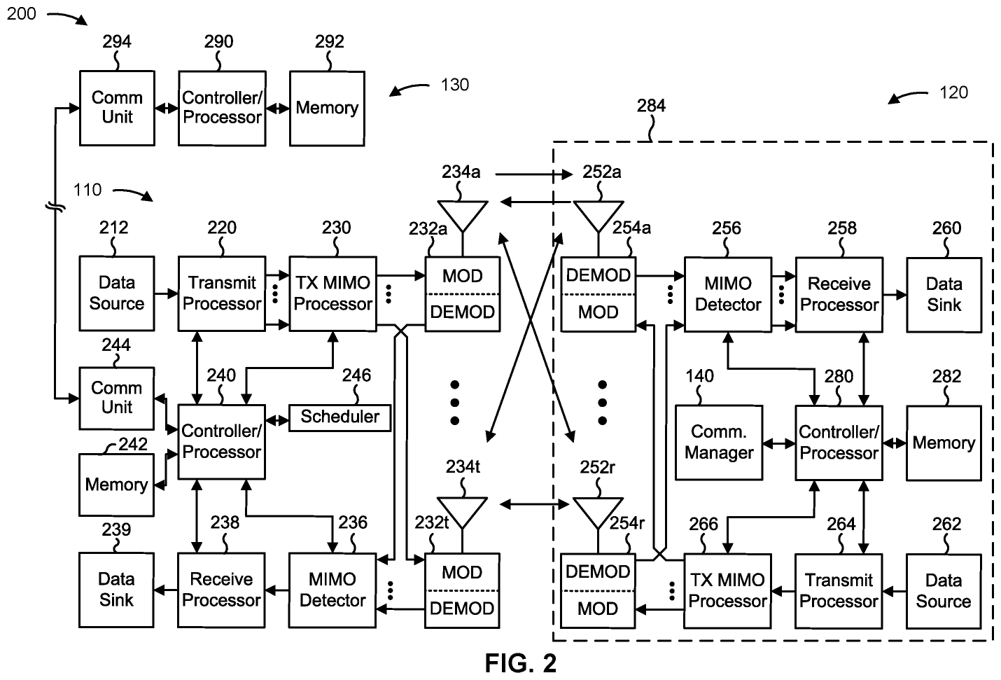

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

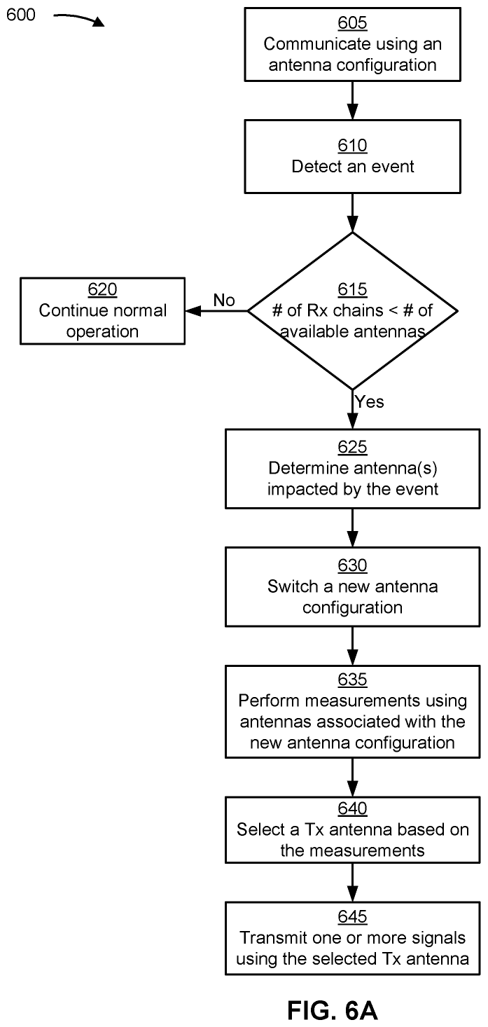

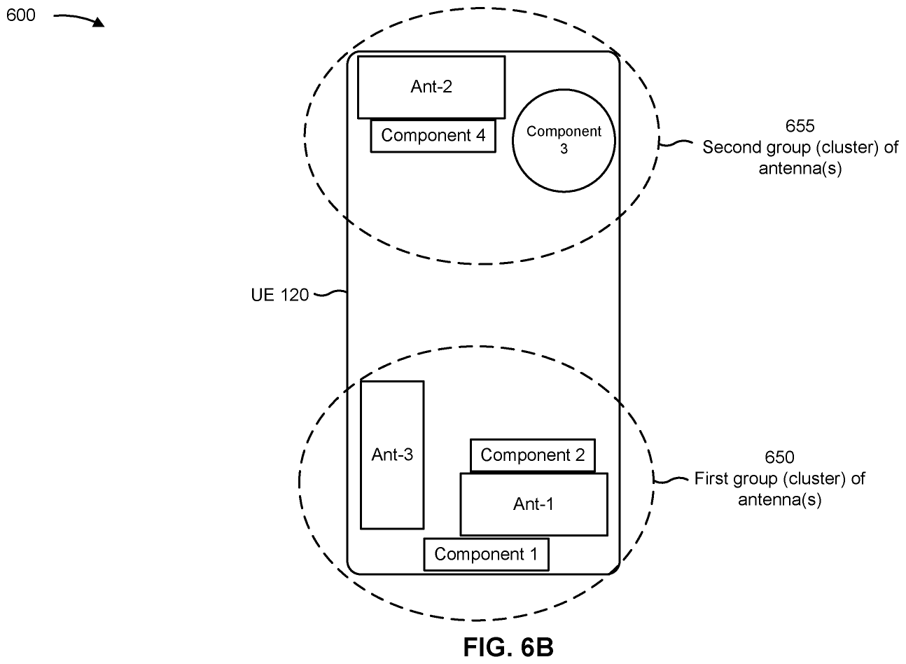

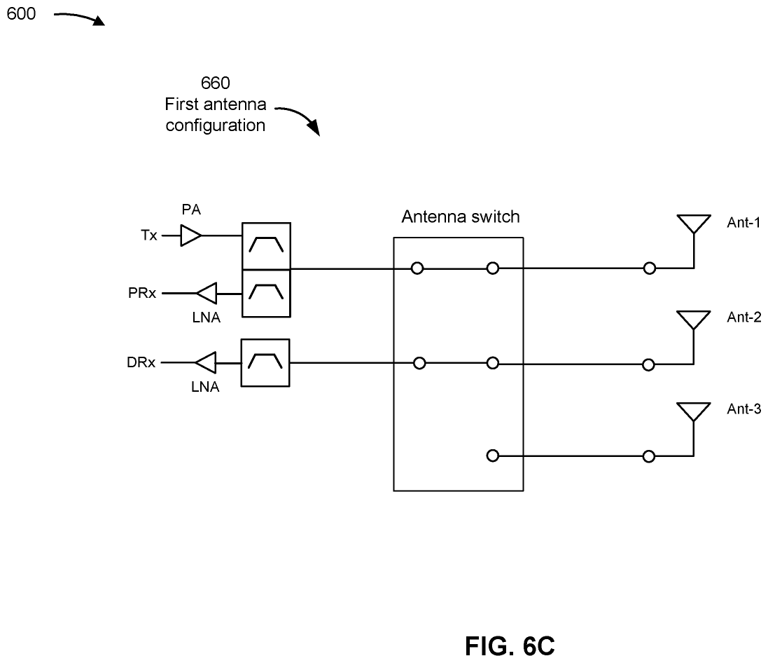

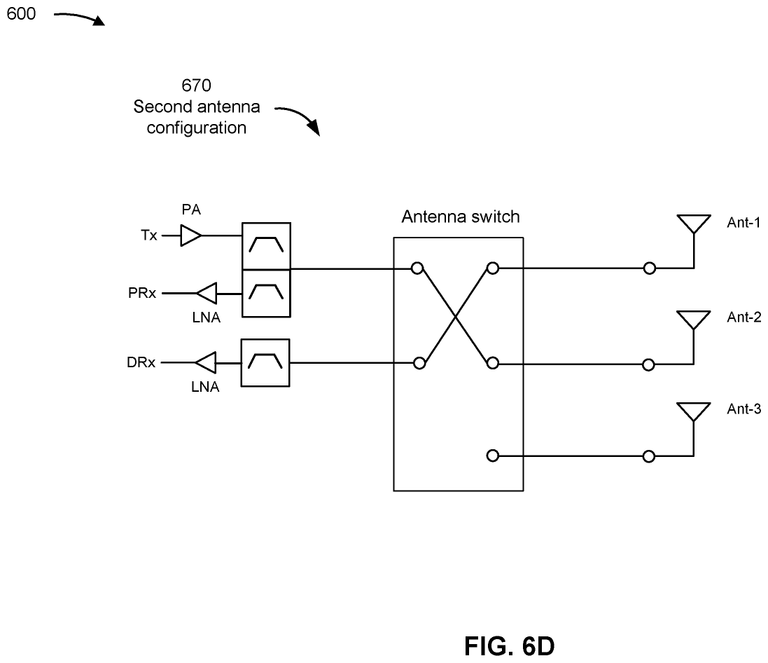

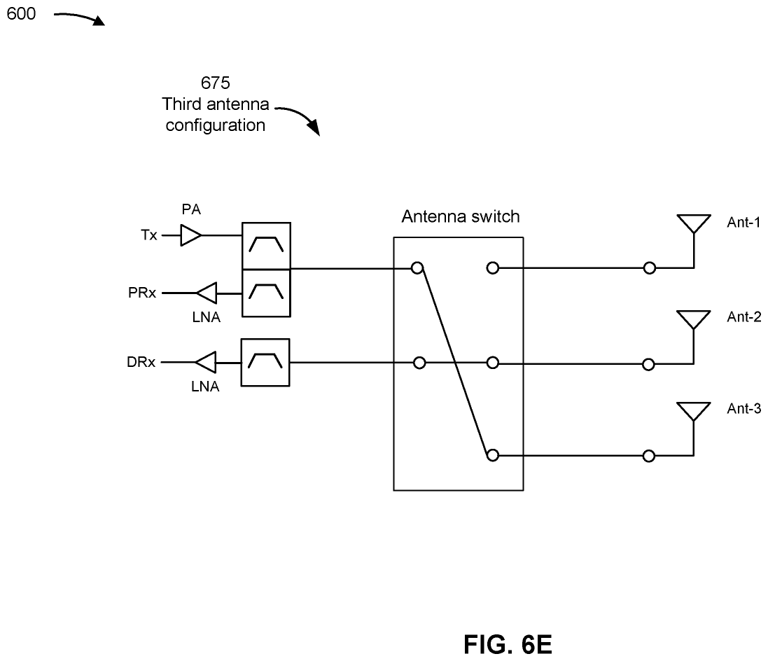

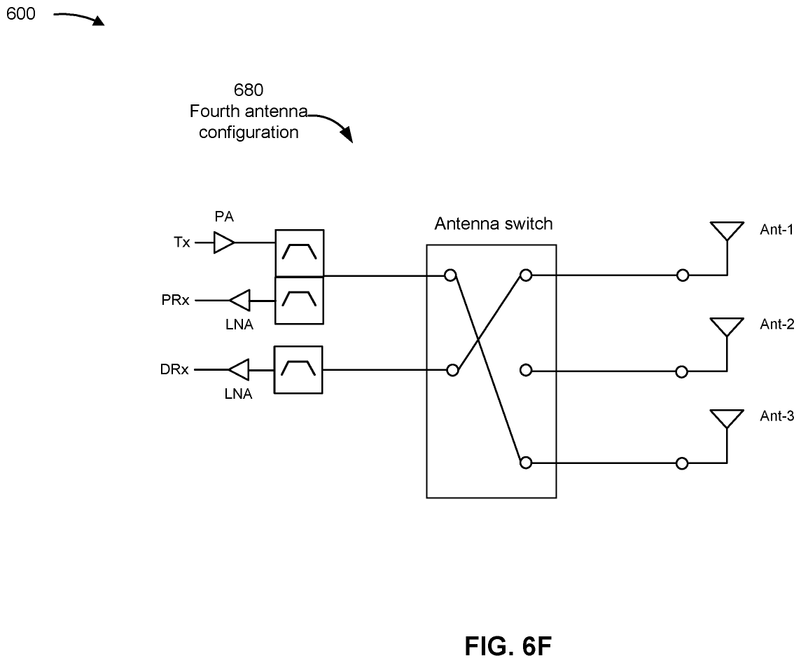

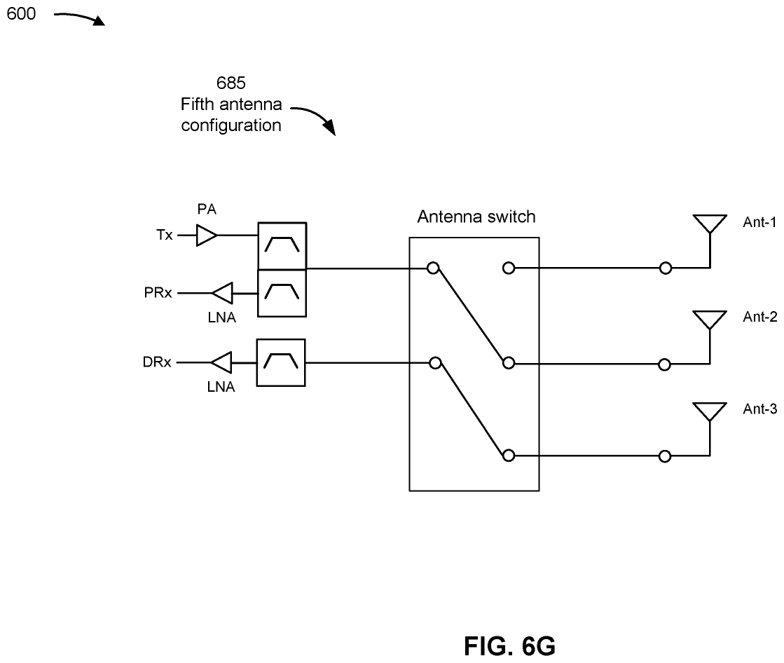

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6A-6G, 7, and 8).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6A-6G, 7, and 8).

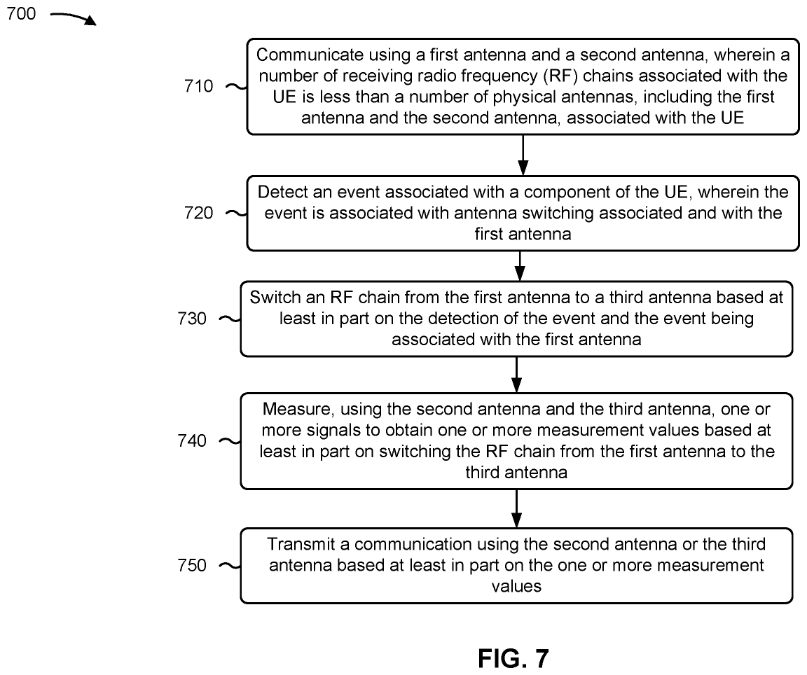

The controller/processor 240 of the base station 110, the controller/processor 280 of the UE 120, and/or any other component(s) of FIG. 2 may perform one or more techniques associated with UE component event based antenna switching, as described in more detail elsewhere herein. For example, the controller/processor 240 of the base station 110, the controller/processor 280 of the UE 120, and/or any other component(s) of FIG. 2 may perform or direct operations of, for example, process 700 of FIG. 7, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, and/or other processes as described herein. In some examples, executing instructions may include running the instructions, converting the instructions, compiling the instructions, and/or interpreting the instructions, among other examples.

In some aspects, the UE 120 includes means for communicating using a first antenna and a second antenna, wherein a number of receiving RF chains associated with the UE is less than a number of physical antennas, including the first antenna and the second antenna, associated with the UE; means for detecting an event associated with a component of the UE, wherein the event is associated with antenna switching and with the first antenna; means for switching an RF chain from the first antenna to a third antenna based at least in part on the detection of the event and the event being associated with the first antenna; means for measuring, using the second antenna and the third antenna, one or more signals to obtain one or more measurement values based at least in part on switching the RF chain from the first antenna to the third antenna; and/or means for transmitting a communication using the second antenna or the third antenna based at least in part on the one or more measurement values. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, a base station, or a network equipment may be implemented in an aggregated or disaggregated architecture. For example, a base station (such as a Node B (NB), evolved NB (eNB), NR base station (BS), 5G NB, gNodeB (gNB), access point (AP), TRP, or cell), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more central units (CUs), one or more distributed units (DUs), one or more radio units (RUs), or a combination thereof).

An aggregated base station may be configured to utilize a radio protocol stack that is physically or logically integrated within a single RAN node (for example, within a single device or unit). A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also may be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that may be individually deployed. A disaggregated base station may include functionality implemented across two or more units at various physical locations, as well as functionality implemented for at least one unit virtually, which may enable flexibility in network design. The various units of the disaggregated base station may be configured for wired or wireless communication with at least one other unit of the disaggregated base station.

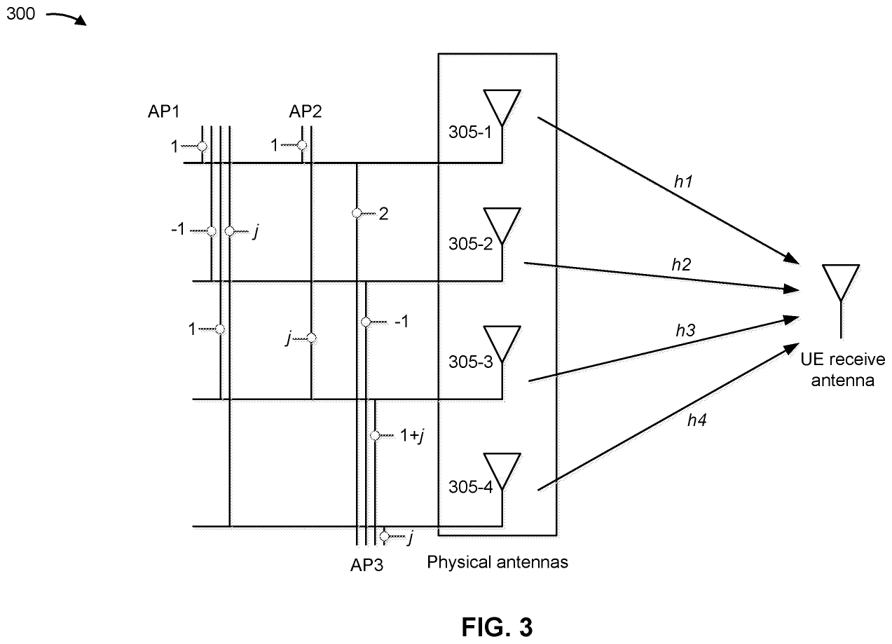

FIG. 3 is a diagram illustrating an example 300 of antenna ports, in accordance with the present disclosure.

As shown in FIG. 3, a first physical antenna 305-1 may transmit information via a first channel h1, a second physical antenna 305-2 may transmit information via a second channel h2, a third physical antenna 305-3 may transmit information via a third channel h3, and a fourth physical antenna 305-4 may transmit information via a fourth channel h4. Such information may be conveyed via a logical antenna port, which may represent some combination of the physical antennas and/or channels. In some cases, a UE 120 may not have knowledge of the channels associated with the physical antennas, and may only operate based on knowledge of the channels associated with antenna ports, as defined below.

An antenna port may be defined such that a channel, over which a symbol on the antenna port is conveyed, can be inferred from a channel over which another symbol on the same antenna port is conveyed. In example 300, a channel associated with antenna port 1 (AP1) is represented as h1−h2+h3+j*h4, where channel coefficients (e.g., 1, −1, 1, and j, in this case) represent weighting factors (e.g., indicating phase and/or gain) applied to each channel. Such weighting factors may be applied to the channels to improve signal power and/or signal quality at one or more receivers. Applying such weighting factors to channel transmissions may be referred to as precoding, and a precoder may refer to a specific set of weighting factors applied to a set of channels.

Similarly, a channel associated with antenna port 2 (AP2) is represented as h1+j*h3, and a channel associated with antenna port 3 (AP3) is represented as 2*h1−h2+ (1+j) *h3+j*h4. In this case, antenna port 3 can be represented as the sum of antenna port 1 and antenna port 2 (e.g., AP3=AP1+AP2) because the sum of the expression representing antenna port 1 (h1−h2+h3+j*h4) and the expression representing antenna port 2 (h1+j*h3) equals the expression representing antenna port 3 (2*h1−h2+(1+j) *h3+j*h4). It can also be said that antenna port 3 is related to antenna ports 1 and 2 [AP1,AP2] via the precoder [1,1] because 1 times the expression representing antenna port 1 plus 1 times the expression representing antenna port 2 equals the expression representing antenna port 3.

In some cases, an antenna port and/or a physical antenna may be mapped to a receiving RF chain and/or a transmitting RF chain of a UE (e.g., a UE 120). For example, the UE 120 may configure the receiving RF chain and/or the transmitting RF chain to be associated with a given antenna port and/or physical antenna. In some cases, the UE 120 may dynamically switch the receiving RF chain and/or the transmitting RF chain between various antenna ports and/or physical antennas based on channel conditions, among other examples (e.g., as described in more detail elsewhere herein).

As indicated above, FIG. 3 is provided merely as an example. Other examples may differ from what is described with regard to FIG. 3.

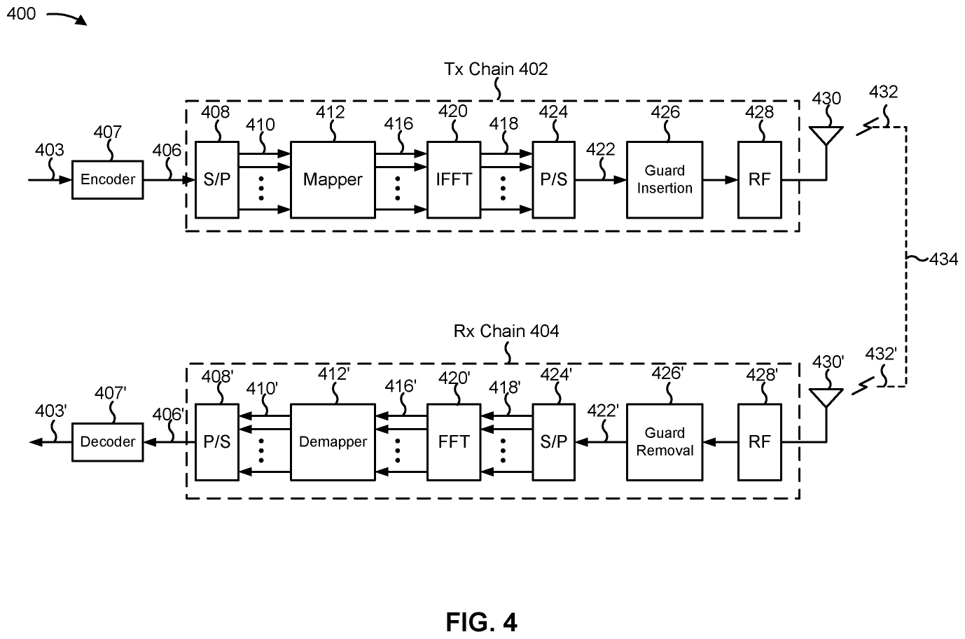

FIG. 4 is a diagram illustrating an example 400 of a transmit (Tx) chain 402 and a receive (Rx) chain 404 of a UE 120, in accordance with the present disclosure. The Tx chain 402 may be referred to herein as a transmitting RF chain. Similarly, the Rx chain 404 may be referred to herein as a receiving RF chain. In some aspects, one or more components of Tx chain 402 may be implemented in transmit processor 264, TX MIMO processor 266, modem 254, and/or controller/processor 280, as described above in connection with FIG. 2. In some examples, Tx chain 402 may be implemented in UE 120 for transmitting data 406 (e.g., uplink data, an uplink reference signal, and/or uplink control information) to base station 110 on an uplink channel.

An encoder 407 may alter a signal (e.g., a bitstream) 403 into data 406. Data 406 to be transmitted is provided from encoder 407 as input to a serial-to-parallel (S/P) converter 408. In some aspects, S/P converter 408 may split the transmission data into N parallel data streams 410.

The N parallel data streams 410 may then be provided as input to a mapper 412. Mapper 412 may map the N parallel data streams 410 onto N constellation points. The mapping may be done using a modulation constellation, such as binary phase-shift keying (BPSK), quadrature phase-shift keying (QPSK), and/or 8 phase-shift keying (8PSK), quadrature amplitude modulation (QAM), among other examples. Thus, mapper 412 may output N parallel symbol streams 416, each symbol stream 416 corresponding to one of N orthogonal subcarriers of an inverse fast Fourier transform (IFFT) component 420. These N parallel symbol streams 416 are represented in the frequency domain and may be converted into N parallel time domain sample streams 418 by IFFT component 420.

In some examples, N parallel modulations in the frequency domain correspond to N modulation symbols in the frequency domain, which are equal to N mapping and N-point IFFT in the frequency domain, which are equal to one (useful) OFDM symbol in the time domain, which are equal to N samples in the time domain. One OFDM symbol in the time domain, Ns, is equal to Nop (the number of guard samples per OFDM symbol)+N (the number of useful samples per OFDM symbol).

The N parallel time domain sample streams 418 may be converted into an OFDM/OFDMA symbol stream 422 by a parallel-to-serial (P/S) converter 424. A guard insertion component 426 may insert a guard interval between successive OFDM/OFDMA symbols in the OFDM/OFDMA symbol stream 422. The output of guard insertion component 426 may then be upconverted to a desired transmit frequency band by an RF front end 428. An antenna 430 may then transmit the resulting signal 432. The RF front end 428 may include one or more components, such as one or more power amplifiers (PAS), one or more low noise amplifiers (LNAs), and/or one or more antenna switches (e.g., one or more antenna cross switches), among other examples.

In some aspects, Rx chain 404 may utilize OFDM/OFDMA. In some aspects, one or more components of Rx chain 404 may be implemented in receive processor 258, MIMO detector 256, modem 254, and/or controller/processor 280, as described above in connection with FIG. 2. In some aspects, Rx chain 404 may be implemented in UE 120 for receiving data 406 (e.g., downlink data, a downlink reference signal, and/or downlink control information) from base station 110 on a downlink channel.

A transmitted signal 432 is shown traveling over a wireless channel 434 from Tx chain 402 to Rx chain 404. When a signal 432′ is received by an antenna 430′, the received signal 432′ may be downconverted to a baseband signal by an RF front end 428′. A guard removal component 426′ may then remove the guard interval that was inserted between OFDM/OFDMA symbols by guard insertion component 426.

The output of guard removal component 426′ may be provided to an S/P converter 424′. The output may include an OFDM/OFDMA symbol stream 422′, and S/P converter 424′ may divide the OFDM/OFDMA symbol stream 422′ into N parallel time-domain symbol streams 418′, each of which corresponds to one of the N orthogonal subcarriers. A fast Fourier transform (FFT) component 420′ may convert the N parallel time-domain symbol streams 418′ into the frequency domain and output N parallel frequency-domain symbol streams 416′.

A demapper 412′ may perform the inverse of the symbol mapping operation that was performed by mapper 412, thereby outputting N parallel data streams 410′. A P/S converter 408′ may combine the N parallel data streams 410′ into a single data stream 406′. Ideally, data stream 406′ corresponds to data 406 that was provided as input to Tx chain 402. Data stream 406′ may be decoded into a decoded data stream 403′ by decoder 407′.

The number and arrangement of components shown in FIG. 4 are provided as an example. In practice, there may be additional components, fewer components, different components, or differently arranged components than those shown in FIG. 4. Furthermore, two or more components shown in FIG. 4 may be implemented within a single component, or a single component shown in FIG. 4 may be implemented as multiple, distributed components. Additionally, or alternatively, a set of components (e.g., one or more components) shown in FIG. 4 may perform one or more functions described as being performed by another set of components shown in FIG. 4.

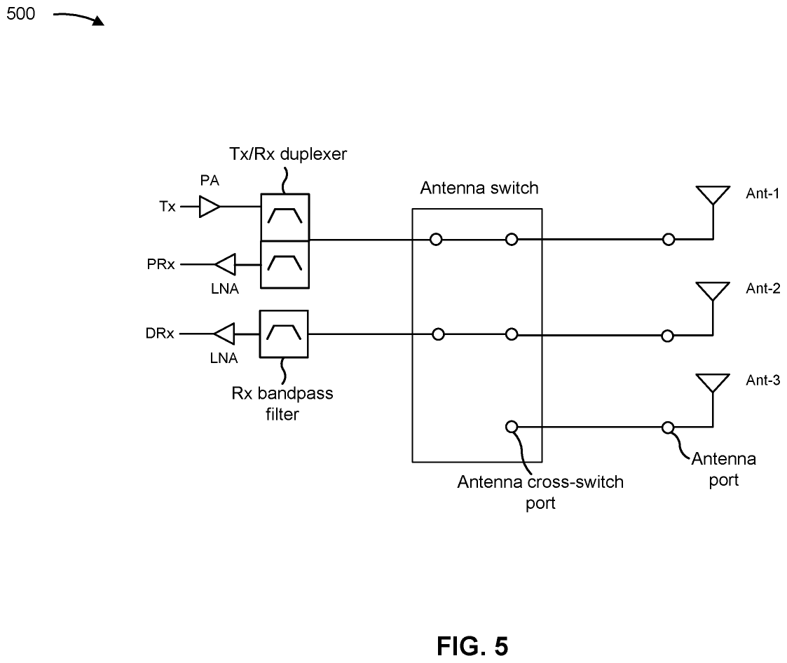

FIG. 5 is a diagram illustrating an example 500 of an RF front end architecture of a UE 120, in accordance with the present disclosure. For example, the RF front end architecture may include multiple antennas (e.g., physical antennas), shown as Ant-1, Ant-2, and Ant-3. Each antenna may be associated with an antenna port (e.g., in a similar manner as described in connection with FIG. 3).

The RF front end architecture may include an antenna switch, such as an antenna cross-switch. The antenna switch may include multiple antenna cross-switch ports. As shown in FIG. 5, a given antenna port of an antenna may be mapped to, or associated with, a given antenna cross-switch port. The antenna switch may be capable of configuring or routing a path for signals transmitted or received by the UE 120 to a given antenna. The RF front end architecture may include a Tx chain (shown in FIG. 5 as “Tx”) with a PA configured to transmit (e.g., deliver power) towards the multiple antennas. The RF front end architecture may include a first Rx chain (shown in FIG. 5 as “PRx”). The first Rx chain may be a primary Rx chain of the UE 120. The first Rx chain may include an LNA. As shown in FIG. 5, the Tx chain and the first Rx chain may be associated with the same antenna cross-switch port of the antenna switch. For example, the Tx chain and the first Rx chain may be coupled to a Tx/Rx duplexer. In some cases, communications transmitted and/or received by the UE 120 may use frequency division duplexing (FDD), such that a first signal may be received by the UE 120 at a time that at least partially overlaps with a transmission of a second signal by the UE 120 (e.g., where the first signal and the second signal are associated with different frequencies). The Tx/Rx duplexer may be configured to enable bi-directional communication via a single path (e.g., by isolating signals associated with the first receiving RF chain from signals associated with the transmitting RF chain, while permitting the first receiving RF chain and the transmitting RF chain to share a common antenna (e.g., Ant-1 as shown in FIG. 5)). An antenna that is shared between a transmitting RF chain and a receiving RF chain may be referred to herein as a “Tx/Rx antenna.”

The RF front end architecture may include a second receiving RF chain (e.g., shown in FIG. 5 as “DRx”). The second receiving RF chain may be a secondary receiving RF chain or a diversity receiving RF chain. The second receiving RF chain may also include an LNA. The second receiving RF chain may be coupled to one or more filters, such as a receive bandpass filter, among other examples. As shown in FIG. 5, the second receiving RF chain may be associated with an antenna cross-switch port of the antenna switch.

In some cases, the UE 120 may be enabled to select a particular antenna to be associated with the transmitting RF chain based at least in part on measurements associated with antennas of the UE 120. For example, antenna selection may be performed (e.g., based on an antenna switched diversity (Asdiv) technique and/or a sounding reference signal (SRS) antenna switching configuration) to connect the transmitting RF chain to an antenna that is associated with the best metrics or parameters. For example, the UE 120 may perform antenna switching (e.g., based on an Asdiv technique and/or an SRS antenna switching configuration) to identify a best antenna (e.g., an antenna associated with a best or highest measurement parameter, such as an RSRP parameter, transmit power headroom, and/or a signal-to-noise ratio (SNR) parameter) among the available antennas of the UE 120. For example, the UE may reconfigure an antenna associated with the transmitting RF chain to a best available transmit antenna based on one or more measurements (e.g., by reconfigure the antenna switch to map the transmitting RF chain to the best available antenna). As shown in FIG. 5, the available antennas for antenna switching may include Ant-1, Ant-2, and Ant-3.

In the configuration depicted in FIG. 5, the UE 120 may use a first antenna (e.g., Ant-1) as a Tx/Rx antenna (e.g., where the first antenna is used to transmit signals associated with the transmitting RF chain and to receive signals associated with the first receiving RF chain) and a second antenna (e.g., Ant-2) as an Rx antenna (e.g., where the second antenna is used to receive signals associated with the second receiving RF chain). As shown in FIG. 5, a third antenna (e.g., Ant-3) may be available to be used by the UE 120, but may not be configured to transmit or receive signals. For example, previously, UEs communicating using a low band frequency (e.g., below a 960 MHz spectrum) typically included a same number of physical antennas as a number of receiving RF chains associated with the UE (e.g., due to a size of the physical antennas used for low band frequencies and due to limited available space within a UE). However, it may be beneficial to add a third antenna (e.g., Ant-3) in some cases to improve performance of the UE 120.

For example, increasing a number of antennas available for transmitting and/or receiving signals may improve antenna diversity for the UE 120, thereby increasing a likelihood that a suitable antenna will be available for use by the UE 120. For example, in some cases, a user may place their hand or other body part near an antenna causing a blockage of the antenna. Additionally, a user touching or pressing a display screen of the UE 120 near a location of an antenna may cause degradation to a performance of the antenna (e.g., because the antenna may be blocked or an electrical connection associated with the antenna may experience a short circuit because of the pressing of the display screen). As another example, in some cases, a component of the UE (e.g., when the component is in use) may cause degradation to a performance of an antenna and/or a use of an antenna may cause degradation to a performance of a component of the UE. For example, the UE 120 may include a charging port (e.g., a universal serial bus (USB) port, a Lightning port, or another port used to charge a battery of the UE 120). The charging port, when in use, may be coupled to a charging cable that carries current to enable the batter of the UE 120 to be charged. However, a charged cable (e.g., that is carrying current) connected to the charging port may generate harmonics in an RF frequency that may cause interference or reduced efficiency for an antenna located near the charging port. As another example, one or more components (such as a camera, among other examples) of the UE 120 may utilize clocks associated with a given frequency. In some cases, a signal transmitted by an antenna of the UE 120 may cause interference and/or degraded performance of the clock (e.g., and thereby degraded performance of the component using the clock) if harmonics from the transmission of the signal fall into the frequency (or a multiple of the frequency) used by the clock. Therefore, it may be beneficial to add one or more additional antennas that are available to be used (e.g., available to be switched to) by the UE 120.

As described above, the UE 120 may rely on measurements performed by receiving signals via one or more antennas and subsequently measuring the received signals (e.g., using an Asdiv technique or another antenna switching technique). However, in some cases (e.g., as shown in FIG. 5), the UE 120 may be associated with less receiving RF chains than a number of antennas that are available to be used (e.g., available to be switched to) by the UE 120. For example, in the RF front end architecture shown in FIG. 5, the UE 120 may include 2 receiving RF chains and 3 physical antennas that are available to be used (e.g., available to be switched to) by the UE 120. As a result, at a given time or over a given period of time, the UE 120 may not be capable of measuring signals via all of the available antennas (e.g., the UE 120 may only be capable of measuring signals via 2 of the 3 antennas at a given time or over a given period of time in the example depicted in FIG. 5).

As a result, one or more antennas that are available to be used by the UE 120 may not be measured or used as part of an antenna switching procedure for selecting a best transmit antenna, such as an Asdiv procedure or another antenna switching procedure. Therefore, the UE 120 may not have measurements (or may not have recent measurements) associated with one or more antennas that are available to be used by the UE 120. As a result, an evaluation of the available antennas by the UE 120 for selecting a best transmit antenna may be degraded. For example, the UE 120 may select an antenna to serve as the transmit antenna (e.g., to be associated with the transmitting RF chain) that has not been recently measured (e.g., via receiving a signal via the antenna), which may result in selecting an antenna to serve as the transmit antenna that is associated with poor metrics (e.g., a low RSRP, or a low SNR, among other examples). Additionally, some events triggering an antenna switch (e.g., associated with a component of the UE, as described above) may be associated with a given antenna and/or a given physical location on the UE 120. Therefore, in some cases, the UE 120 may switch to an antenna that is still impacted by the event that triggered the antenna switch, resulting in degraded communication performance of the UE 120.

Some techniques and apparatuses described herein enable UE component event-based antenna switching. For example, the UE 120 may communicate using a first antenna (e.g., as a Tx/Rx antenna or an Rx antenna) and a second antenna (e.g., as an Rx antenna or a Tx/Rx antenna) where a number of receiving RF chains associated with the UE 120 is less than a number of physical antennas, including the first antenna and the second antenna, that are available for use by the UE 120. The UE 120 may detect an event associated with a component of the UE, where the event is associated with policy information (e.g., indicating information associated with antenna switching associated with the event).

The UE 120 may switch an RF chain (e.g., transmitting RF chain and a first receiving RF chain (e.g., if the first antenna is a Tx/Rx antenna) or a second receiving RF chain (e.g., if the first antenna is an Rx antenna)) from the first antenna to a third antenna based at least in part on the detection of the event and the policy information (e.g., where the policy information indicates that the first antenna is impacted by the event). For example, the UE 120 may reconfigure an antenna switch to route a path (e.g., a Tx/Rx path or an Rx path) that was previously associated with the first antenna to the third antenna based at least in part on the detection of the event. In some aspects, the UE 120 may measure, using the second antenna and the third antenna, one or more signals to obtain one or more measurement values based at least in part on switching to the third antenna (e.g., switching to the third antenna may trigger the UE 120 to perform one or more measurements). The UE 120 may transmit a communication using the second antenna or the third antenna as based at least in part on the one or more measurement values (e.g., the UE 120 may select a transmit antenna, from the second antenna and the third antenna, to be used to transmit the communication based at least in part on the one or more measurement values).

As a result, the UE 120 may be enabled to perform antenna switching (e.g., event-based antenna switching) when a number of receiving RF chains associated with the UE 120 is less than a number of physical antennas that are available for use by the UE 120 (e.g., that are available to be switched to). For example, the UE 120 may be enabled to make improved determinations as to an antenna to be switched based on the detection of an event (e.g., based at least on the stored policy information) to quickly switch away from an antenna that is negatively impacted by the event. Additionally, the UE 120 may be enabled to quickly perform measurements via the active antennas after the antenna switch to make an improved transmit antenna selection. Therefore, the UE 120 may realize significant improvements in antenna performance by enabling the UE 120 to be aware of external events that impact antenna performance and enabling the UE 120 to re-map a current antenna configuration to another antenna configuration that minimizes the effect of the event on antenna performance.

The number and arrangement of components shown in FIG. 5 are provided as an example. In practice, there may be additional components, fewer components, different components, or differently arranged components than those shown in FIG. 5. For example, in some cases, a UE 120 may include more than 1 transmitting RF chain, more than 2 receiving RF chains, and/or more than 3 physical antennas, among other examples. Furthermore, two or more components shown in FIG. 5 may be implemented within a single component, or a single component shown in FIG. 5 may be implemented as multiple, distributed components. Additionally, or alternatively, a set of components (e.g., one or more components) shown in FIG. 5 may perform one or more functions described as being performed by another set of components shown in FIG. 5.

FIGS. 6A-6G are diagrams illustrating an example 600 associated with UE component event-based antenna switching, in accordance with the present disclosure. FIG. 6A depicts an example process where a UE (e.g., the UE 120) performs operations associated with UE component event-based antenna switching. As depicted in FIGS. 6B-6G, the UE 120 may be associated with multiple physical antennas (e.g., Ant-1, Ant-2, and Ant-3). While example 600 describes three physical antennas, the UE 120 may include a different number of physical antennas (e.g., four, six, ten, or another number). A number of receiving RF chains associated with the UE 120 may be less than a number of physical antennas associated with the UE 120. In the example depicted in FIGS. 6A-6G, the UE 120 may be associated with two receiving RF chains and three physical antennas (e.g., that are available for antenna switching). In other aspects, the operations described herein may be similarly applied where the UE 120 includes a different number of receiving RF chains and/or a different number physical antennas so long as the number of receiving RF chains is less than the number of physical antennas.

As shown in FIG. 6A, and by reference number 605, the UE 120 may communicate using a first antenna configuration. For example, the UE 120 may communicate (e.g., transmit and/or receive) one or more signals using at least a first antenna and a second antenna associated with the UE 120 (e.g., using Ant-1 and Ant-2). For example, the first configuration may be a first antenna configuration 660 depicted in FIG. 6C (e.g., where the Ant-1 is a Tx/Rx antenna and the Ant-2 is an Rx antenna). As another example, the first configuration may be a second antenna configuration 670 depicted in FIG. 6D (e.g., where the Ant-1 is an Rx antenna and the Ant-2 is a Tx/Rx antenna). In the first antenna configuration, a third antenna (e.g., the Ant-3) and/or one or more other antennas of the UE 120 may not be used (e.g., may not be mapped to or associated with an RF chain of the UE 120). Therefore, using the first antenna configuration, the UE 120 may be unable to measure signals received via the Ant-3 because the Ant-3 is not associated with, or mapped to, a receiving RF chain of the UE 120.

As shown by reference number 610, the UE 120 may detect an event associated with a component of the UE 120. The component may be a component external to a modem of the UE 120. For example, the component may be a charging port (e.g., a USB port, a Lightning port, or another type of charging port), a peripheral device, an input/output device (e.g., a button, a microphone, a speaker, or another device), a camera, a sensor (e.g., a touch sensor, a motion sensor, a pressure sensor, a capacitive touch sensor, or another type of sensor), and/or another device connected to or associated with the UE 120. Detecting the event may include detecting that the component is active (e.g., in use or in an “on” state). For example, the modem of the UE 120 may receive an indication from another device (e.g., a processor, an application processor, the component, or another device associated with the UE 120) indicating that the event is active or is occurring. For example, the modem may receive or obtain an indication (e.g., a flag) indicating that the event is active or is occurring (e.g., where the flag indicates “TRUE” or a value of “1”). The flag may be persistent and may continue to indicate that the event is occurring until the event is no longer occurring (e.g., until the component associated with the event transitions to an inactive state or an off state). Based at least in part on receiving the indication at the modem, the UE 120 may detect the event (e.g., may detect that the event is active or occurring).

As shown by reference number 615, the UE 120 may determine whether a number of receiving RF chains of the UE 120 is less than a number of physical antennas that are available for antenna switching. For example, the UE 120 may determine whether a criteria of a hardware capability of the UE 120 of the total Tx/Rx transmitters/receivers being less than a total available physical antennas that be accessed via antenna switching is met. For example, the UE 120 may store information associated with hardware capabilities of the UE 120. The hardware capabilities may include an indication of a number of physical antennas that are available for antenna switching and a quantity of receiving RF chains associated with the UE 120. In some aspects, as shown by reference number 620, if the number of receiving RF chains of the UE 120 is equal to or greater than the number of physical antennas that are available for antenna switching, then the UE 120 may continue with normal operations (e.g., may not proceed with the event-based antenna switching as described in more detail elsewhere herein). If the number of receiving RF chains of the UE 120 is less than the number of physical antennas that are available for antenna switching, then the UE 120 may proceed with one or more operations associated with event-based antenna switching. as described in more detail elsewhere herein.

For example, as shown by reference number 625, the UE 120 may determine one or more antennas that are associated with, or impacted by, the detected event. For example, the UE 120 may determine or identify antennas that are currently being used by the UE 120 based at least in part on a current antenna configuration of the UE 120 (e.g., Ant-1 and Ant-2, as described above). In some aspects, the UE 120 may identify a group or cluster of antennas associated with active antennas (e.g., one or more groups or clusters that include an antenna that is currently being used by the UE 120).

For example, as shown in FIG. 6B, the UE 120 may be associated with one or more groups (e.g., clusters) of antennas. For example, as shown in FIG. 6B, the UE 120 may be associated with at least a first group 650 of one or more antennas and a second group 655 of one or more antennas. In some aspects, the UE 120 may be associated with more than two groups of antennas. The first group 650 of antennas may include a first one or more antennas (e.g., Ant-1 and Ant-2) that are associated with a first physical area of the UE 120 (e.g., a lower half of the UE 120 as depicted in FIG. 6B). The second group 655 of antennas may include a second one or more antennas (e.g., Ant-2) that are associated with a second physical area of the UE 120 (e.g., an upper half of the UE 120 as depicted in FIG. 6B). In other words, antennas may be grouped or clustered based at least in part on the physical location of the antennas on a body of the UE 120. The UE 120 may store information (e.g., hardware capability information) indicating groups or clusters of UEs. The information may indicate antennas that are included in a given group or cluster.

Returning to FIG. 6A, the UE 120 may determine which groups or clusters of antennas are currently being used by the UE 120 based at least in part on a current antenna configuration of the UE 120. For example, if the Ant-1 and the Ant-2 are currently being used by the UE 120, then the UE 120 may determine that the first group 650 and the second group 655 are being used by the UE 120.

In some aspects, the UE 120 may determine antennas and/or groups of antennas that are affected by the event. For example, the event may be associated with policy information. The policy information may indicate information for antenna switching associated with the event. For example, the policy information may indicate one or more antennas and/or one or more groups of antennas that are impacted by the event being active. The UE 120 may store the policy information in a memory of the UE 120 and may access or retrieve the policy information based at least in part on detecting the event.

In some aspects, the policy information may indicate one or more antennas and/or one or more groups (e.g., clusters) of antennas that should not be used, or that should be avoided, by the UE 120 when the event is active or is occurring. For example, as shown in FIG. 6B and as described in more detail elsewhere herein, an event may be associated with a given component of the UE 120 being active or in an on state. For example, the UE 120 may include a first component (e.g., “Component 1”). As an example, the first component may be a charging port of the UE 120. Because the charging port being active may cause interference to nearby antennas, the policy information associated with the first component (e.g., where the event includes the first component being active) may indicate that the Ant-1 and/or the first group 650 is not to be used by the UE 120 when the event is detected. As another example, the UE 120 may include a second component (e.g., “Component 2”). As an example, the second component may be a sensor associated with the Ant-1 (e.g., a capacitive touch sensor or another sensor that indicates when a user is touching or has a body part near an area of the UE 120 associated with the Ant-1). Because a user touching an area near a physical location of the Ant-1 may cause degraded performance of the Ant-1, the policy information associated with the second component (e.g., where the event includes the second component being active) may indicate that the Ant-1 and/or the first group 650 is not to be used by the UE 120 when the event is detected.

As another example, the UE 120 may include a third component (e.g., “Component 3”). As an example, the third component may be a peripheral device associated with the UE 120, such as a camera, that includes a clock associated with a given frequency. As described in more detail elsewhere herein, because a transmission from an antenna proximate to the third device may cause degraded performance of the clock (e.g., and the third component as a result), the policy information associated with the third component (e.g., where the event includes the third component being active) may indicate that the Ant-2 and/or the second group 655 is not to be used by the UE 120 when the event is detected. As another example, the UE 120 may include a fourth component (e.g., “Component 4”). As an example, the fourth component may be a sensor associated with the Ant-2 (e.g., a capacitive touch sensor or another sensor that indicates when a user is touching or has a body part near an area of the UE 120 associated with the Ant-2). Because a user touching an area near a physical location of the Ant-2 may cause degraded performance of the Ant-2, the policy information associated with the fourth component (e.g., where the event includes the fourth component being active) may indicate that the Ant-2 and/or the second group 655 is not to be used by the UE 120 when the event is detected.

In some aspects, the policy information may indicate whether the UE 120 is to switch from an impacted antenna to another antenna in the same group of antennas or whether the UE 120 is to switch from the impacted antenna to another antenna in a different group of antennas. For example, in some aspects, the policy information may indicate that the UE 120 is to switch from an antenna impacted by the event to another antenna included in the same group or cluster of antennas as the impacted antenna. In some other cases, the policy information may indicate that the UE 120 is to switch from an antenna impacted by the event to another antenna included in a different group or cluster of antennas as the impacted antenna. In other words, the policy information may indicate a mapping function for mapping a current Tx and/or Rx antenna to a candidate Tx and/or Rx antenna (e.g., that has not recently been used by the UE 120 to measure signals, such as the Ant-3) in the same group or cluster of antennas or in a different group or cluster of antennas (e.g., depending on the event that is detected). For example, different events may be associated with different policy information.

Returning to FIG. 6A, as shown by reference number 630, the UE 120 may switch to a new (e.g., second) antenna configuration based at least in part on the detection of the event and/or on antenna(s) impacted by the event (e.g., as indicated by the policy information associated with the event). For example, the policy information may indicate that the first antenna (e.g., Ant-1) is impacted by the event (e.g., may indicate that the first antenna is not to be used by UE 120 when the event is detected, is active, or is occurring). The UE 120 may switch an RF chain from the first antenna to a third antenna (e.g., Ant-3) based at least in part on the detection of the event and the policy information. For example, the third antenna may be an antenna that was not previously associated with, or mapped to, an RF chain of the UE 120. The RF chain may be a transmitting RF chain and/or a receiving RF chain. For example, as depicted in FIGS. 6C-6G, the RF chain may be associated with the Tx RF chain and the first Rx RF chain (e.g., the PRx chain). Alternatively, the RF chain may be associated with the second Rx chain (e.g., the DRx chain). Switching the antenna may include the UE 120 reconfiguring a path for a given RF chain (e.g., via the antenna switch or antenna cross switch associated with the given RF chain).

For example, in some aspects, the policy information associated with the event may indicate that the event is associated with the first group 650 of antennas. In such examples, switching the RF chain from the first antenna to the third antenna is based at least in part on the policy information indicating that the event is associated with the first group 650 of antennas. As another example, the policy information associated with the event may indicate that the event is associated with the first group 650 of antennas and that the UE is to switch the first antenna to another antenna included in the first group 650 of antennas. In such examples, switching the RF chain from the first antenna to the third antenna is based at least in part on the third antenna being included in the first group 650 of antennas. As another example, the policy information associated with the event may indicate that the event is associated with the first group 650 of antennas and that the UE is to switch the first antenna to an antenna included in a group other than the first group 650 of antennas. In such examples, switching the RF chain from the first antenna to the third antenna is based at least in part on the third antenna being included in the second group 655 of antennas (e.g., where the “third” antenna in this example is Ant-2 as depicted in FIGS. 6B-6G). In some aspects, the policy information associated with the event may indicate that a group of antennas (e.g., the second group 655) is not to be used based at least in part on the detection of the event. In such examples, switching the RF chain from the first antenna to the third antenna is based at least in part on the third antenna not being included in the group of antennas (e.g., the second group 655).

In some aspects, the policy information associated with the event may indicate that first antenna is not to be used based at least in part on the detection of the event. Therefore, switching the RF chain from the first antenna to the third antenna is based at least in part on the policy information indicating that the first antenna is not to be used when the event is detected, is active, or is occurring. For example, the policy information may indicate that the event is associated with the first antenna (e.g., that the first antenna is impacted by the event occurring). Therefore, switching the RF chain from the first antenna to the third antenna is based at least in part on the policy information indicating that the event is associated with the first antenna.

In some aspects, switching the RF chain from the first antenna to the third antenna is based at least in part on the first antenna being associated with a transmitting RF chain prior to the detection of the event. In other words, in some aspects, the policy information may indicate that an impacted antenna is to be switched away from only if the impacted antenna is mapped to the transmitting RF chain of the UE 120 when the event is detected (e.g., if the impacted antenna is only mapped to a receiving RF chain, then the UE 120 may not be required to switch away from the impacted antenna in some cases).

In some aspects, if the first antenna configuration used by the UE 120 (e.g., as described in connection with reference number 605) is the first antenna configuration 660 depicted in FIG. 6C, and the policy information associated with the detected event indicates that the first antenna (e.g., Ant-1) is not to be used and that the antenna should be switched to an antenna in the same group or cluster as the first antenna, then the UE 120 may switch to a third antenna configuration 675 that is depicted in FIG. 6E. For example, the UE 120 may switch a path for a transmitting RF chain from the first antenna (Ant-1) to the third antenna (Ant-3), while not changing the path for the second Rx RF chain. As another example, if the first antenna configuration used by the UE 120 (e.g., as described in connection with reference number 605) is the second antenna configuration 670 depicted in FIG. 6D, then the UE 120 may switch to a fifth antenna configuration 685 that is depicted in FIG. 6G. For example, the UE 120 may switch a path for the second receiving RF chain from the first antenna (Ant-1) to the third antenna (Ant-3) while not changing the path for the Tx RF chain. In other words, while the event is active, the UE 120 may only have the Ant-2 and the Ant-3 available for antenna switching (e.g., for an Asdiv procedure).

As another example, the policy information may indicate that the second antenna (e.g., Ant-2) and/or the second group 655 is not to be used by the UE 120. In such examples, if the first antenna configuration used by the UE 120 (e.g., as described in connection with reference number 605) is the second antenna configuration 670 depicted in FIG. 6D, then the UE 120 may switch to a fourth antenna configuration 680 depicted in FIG. 6F. For example, the UE 120 may switch the path for the Tx RF chain from the second antenna (Ant-2) to the third antenna (Ant-3), while not changing that path for the second Rx RF chain. As another example, if the first antenna configuration used by the UE 120 (e.g., as described in connection with reference number 605) is the first antenna configuration 660 depicted in FIG. 6C, then the UE 120 may switch the path for the second Rx RF chain from the second antenna (Ant-2) to the third antenna (Ant-3) while not changing the path for the Tx RF chain. In other words, in such examples, while the event is active, the UE 120 may only have the Ant-1 and the Ant-3 available for antenna switching (e.g., for an Asdiv procedure).

Returning to FIG. 6A, and as shown by reference number 635, the UE 120 may perform one or more measurements using antennas associated with the new antenna configuration. For example, if the UE 120 switches an RF path from the first antenna to the third antenna, then the UE 120 may measure, using the second antenna and the third antenna, one or more signals to obtain one or more measurement values based at least in part on switching the RF chain from the first antenna to the third antenna. In other words, switching the antenna configuration may trigger the UE 120 to perform measurements using the new antenna configuration. In other words, the UE 120 may trigger one or more measurements of signals using the second antenna (Ant-2) and the third antenna (Ant-3) based at least in part on switching a path for an RF chain from the first antenna (Ant-1) to the third antenna. This may enable the UE 120 to obtain measurement values associated with the new antennas to be used to evaluable a best available transmit antenna associated with the new antenna configuration.

In some aspects, the UE 120 may perform the multiple measurements associated with each active antenna associated with the new antenna configuration. In some aspects, the multiple measurements associated with a given antenna may be separated in time by a time gap (e.g., 20 milliseconds, 40 milliseconds, 80 milliseconds, 160 milliseconds, or another amount of time). In some aspects, the UE 120 may perform the multiple measurements associated with a given antenna within a threshold amount of time from switching the antenna configuration. For example, the threshold amount of time may be 160 milliseconds or another amount of time. This may enable the UE 120 to quickly obtain multiple measurement values for each active antenna associated with the new antenna configuration to be used to evaluable a best available transmit antenna associated with the new antenna configuration.

As shown by reference number 640, the UE 120 may select a transmit antenna (e.g., an antenna to be associated with the Tx RF chain) based at least in part on the measurements performed by the UE 120 (e.g., as described above in connection with reference number 635). For example, the UE 120 may compare the measurement values (e.g., RSRP values, SNR values, or remaining power headroom values) to determine a best antenna from the active antennas associated with the new antenna configuration. If the best antenna is associated with the path for the Tx RF chain, then the UE 120 may continue as normal and may not switch the antenna configuration. However, if the best antenna (e.g., as indicated by the one or more measurement values) is not associated with the path for the Tx RF chain, then the UE 120 may switch the antenna configuration. For example, the one or more measurement values include a first one or more measurement values associated with the second antenna and a second one or more measurement values associated with the third antenna. The UE 120 may select (e.g., and transmit using) an antenna, from the second antenna and the third antenna, that is associated with higher measurement values from the first one or more measurement values and the second one or more measurement values.

For example, the UE 120 may switch to the third antenna configuration 675 depicted in FIG. 6E (e.g., where the Ant-3 is associated with the path for the Tx RF chain) based at least in part on the detection of the event (e.g., as described above, such as in connection with reference number 630). However, the one or more measurements performed using the Ant-2 and the Ant-3 (e.g., as described above in connection with reference number 635) may indicate that the Ant-2 is associated with a better or higher measurement value (e.g., thereby indicating that the Ant-2 will be associated with improve transmit performance as comparted to the Ant-3). Therefore, the UE 120 may switch the path for the Tx RF chain from the Ant-3 to the Ant-2. Additionally, the UE 120 may switch the path for the second Rx RF chain (e.g., the DRx chain) from the Ant-2 to the Ant-3 (e.g., because the Ant-1 may be unavailable due to the detection of the event). In other words, based on the measurement(s) performed by the UE 120 indicating that the Ant-2 is associated with better measurement values than the Ant-3, the UE 120 may switch from the third antenna configuration 675 depicted in FIG. 6E to the fifth antenna configuration 685 depicted in FIG. 6G.

Returning to FIG. 6A, and as shown by reference number 645, the UE 120 may transmit one or more signals using the selected Tx antenna. For example, the UE 120 may transmit a communication using the second antenna or the third antenna based at least in part on the one or more measurement values. For example, if the measurement values performed by the UE 120 after the event-based antenna switch occurs indicate that the second antenna is associated with better measurement values than the third antenna, then the UE 120 may transmit the communication using the second antenna. Alternatively, if the measurement values performed by the UE 120 after the event-based antenna switch occurs indicate that the third antenna is associated with better measurement values than the second antenna, then the UE 120 may transmit the communication using the third antenna.

In some aspects, if the UE 120 detects that the event is no longer active, then the UE 120 may switch the antenna configuration used by the UE 120 back to the first antenna configuration used by the UE 120 (e.g., as described in connection with reference number 605).

As a result, the UE 120 may be enabled to perform antenna switching (e.g., event-based antenna switching) when a number of receiving RF chains associated with the UE 120 is less than a number of physical antennas that are available for use by the UE 120 (e.g., that are available to be switched to). For example, the UE 120 may be enabled to make improved determinations as to an antenna to be switched based on the detection of an event (e.g., based at least on the stored policy information) to quickly switch away from an antenna that is negatively impacted by the event. Additionally, the UE 120 may be enabled to quickly perform measurements via the active antennas after the antenna switch to make an improved transmit antenna selection. Therefore, the UE 120 may realize significant improvements in antenna performance by enabling the UE 120 to be aware of external events that impact antenna performance and enabling the UE 120 to re-map a current antenna configuration to another antenna configuration that minimizes the effect of the event on antenna performance.

The number and arrangement of components shown in FIGS. 6A-6G are provided as examples. In practice, there may be additional components, fewer components, different components, or differently arranged components than those shown in FIGS. 6A-6G. Furthermore, two or more components shown in FIGS. 6A-6G may be implemented within a single component, or a single component shown in FIGS. 6A-6G may be implemented as multiple, distributed components. Additionally, or alternatively, a set of components (e.g., one or more components) shown in FIGS. 6A-6G may perform one or more functions described as being performed by another set of components shown in FIGS. 6A-6G.

FIG. 7 is a diagram illustrating an example process 700 performed, for example, by a UE, in accordance with the present disclosure. Example process 700 is an example where the UE (e.g., the UE 120) performs operations associated with techniques for UE component event based antenna switching.

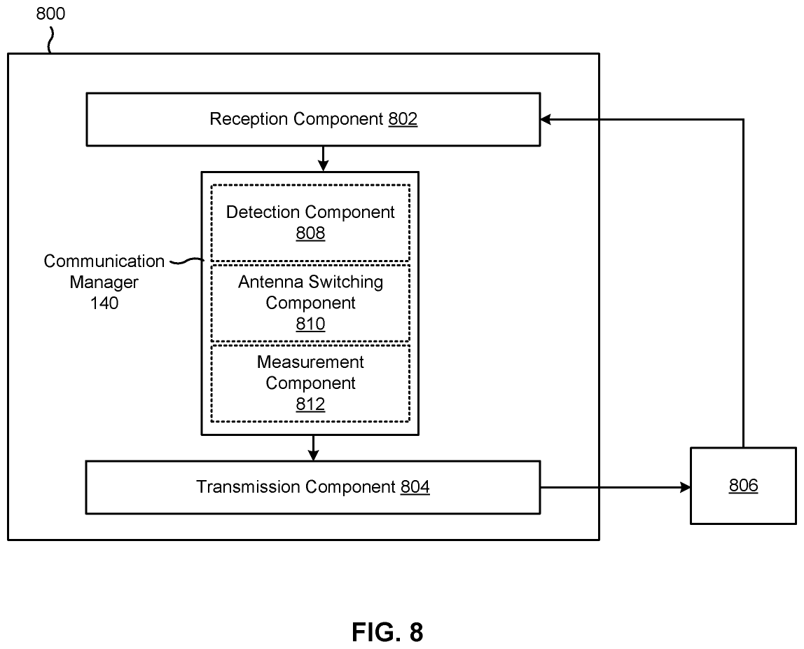

As shown in FIG. 7, in some aspects, process 700 may include communicating using a first antenna and a second antenna, wherein a number of RF chains associated with the UE is less than a number of physical antennas, including the first antenna and the second antenna, associated with the UE (block 710). For example, the UE (e.g., using communication manager 140, reception component 802, and/or transmission component 804, depicted in FIG. 8) may communicate using a first antenna and a second antenna, wherein a number of receiving RF chains associated with the UE is less than a number of physical antennas, including the first antenna and the second antenna, associated with the UE, as described above.

As further shown in FIG. 7, in some aspects, process 700 may include detecting an event associated with a component of the UE, wherein the event is associated with antenna switching and with the first antenna (block 720). For example, the UE (e.g., using communication manager 140 and/or detection component 808, depicted in FIG. 8) may detect an event associated with a component of the UE, wherein the event is associated with antenna switching and with the first antenna, as described above.

As further shown in FIG. 7, in some aspects, process 700 may include switching an RF chain from the first antenna to a third antenna based at least in part on the detection of the event and the event being associated with the first antenna (block 730). For example, the UE (e.g., using communication manager 140 and/or antenna switching component 810, depicted in FIG. 8) may switch an RF chain from the first antenna to a third antenna based at least in part on the detection of the event and the event being associated with the first antenna, as described above.

As further shown in FIG. 7, in some aspects, process 700 may include measuring, using the second antenna and the third antenna, one or more signals to obtain one or more measurement values based at least in part on switching the RF chain from the first antenna to the third antenna (block 740). For example, the UE (e.g., using communication manager 140 and/or measurement component 812, depicted in FIG. 8) may measure, using the second antenna and the third antenna, one or more signals to obtain one or more measurement values based at least in part on switching the RF chain from the first antenna to the third antenna, as described above.

As further shown in FIG. 7, in some aspects, process 700 may include transmitting a communication using the second antenna or the third antenna based at least in part on the one or more measurement values (block 750). For example, the UE (e.g., using communication manager 140 and/or transmission component 804, depicted in FIG. 8) may transmit a communication using the second antenna or the third antenna based at least in part on the one or more measurement values, as described above.

Process 700 may include additional aspects, such as any single aspect or any combination of aspects described below and/or in connection with one or more other processes described elsewhere herein.

In a first aspect, the UE is associated with at least a first group of antennas and a second group of antennas, where the first group of antennas includes a first one or more antennas, from the first antenna, the second antenna, and the third antenna, that are associated with a first physical area of the UE, and the second group of antennas includes a second one or more antennas, from the first antenna, the second antenna, and the third antenna, that are associated with a second physical area of the UE.

In a second aspect, alone or in combination with the first aspect, the first antenna is included in the first group of antennas, where the event is associated with the first group of antennas, and switching the RF chain from the first antenna to the third antenna is based at least in part on the event being associated with the first group of antennas.

In a third aspect, alone or in combination with one or more of the first and second aspects, the first antenna is included in the first group of antennas, where the event is associated with the first group of antennas and with switching the first antenna to another antenna included in the first group of antennas, and switching the RF chain from the first antenna to the third antenna is based at least in part on the third antenna being included in the first group of antennas.

In a fourth aspect, alone or in combination with one or more of the first through third aspects, the first antenna is included in the first group of antennas, where the event is associated with the first group of antennas and with switching the first antenna to an antenna included in a group other than the first group of antennas, and switching the RF chain from the first antenna to the third antenna is based at least in part on the third antenna being included in the second group of antennas.

In a fifth aspect, alone or in combination with one or more of the first through fourth aspects, the first antenna is included in the first group of antennas, the event is associated with the first group of antennas being not to be used based at least in part on the detection of the event, and switching the RF chain from the first antenna to the third antenna is based at least in part on the third antenna not being included in the first group of antennas.

In a sixth aspect, alone or in combination with one or more of the first through fifth aspects, the event is associated with the first antenna being unavailable based at least in part on the detection of the event.

In a seventh aspect, alone or in combination with one or more of the first through sixth aspects, switching the RF chain from the first antenna to the third antenna is based at least in part on the first antenna being associated with a transmitting RF chain prior to the detection of the event.

In an eighth aspect, alone or in combination with one or more of the first through seventh aspects, switching the RF chain from the first antenna to the third antenna is based at least in part on the event being associated with the first antenna.

In a ninth aspect, alone or in combination with one or more of the first through eighth aspects, the one or more measurement values include a first one or more measurement values associated with the second antenna and a second one or more measurement values associated with the third antenna, and process 700 includes transmitting the communication using an antenna, from the second antenna and the third antenna, that is associated with higher measurement values from the first one or more measurement values and the second one or more measurement values.

In a tenth aspect, alone or in combination with one or more of the first through ninth aspects, the detection of the event includes detecting that the component is active.

In an eleventh aspect, alone or in combination with one or more of the first through tenth aspects, the component includes a charging port.

In a twelfth aspect, alone or in combination with one or more of the first through eleventh aspects, the component includes a camera.

In a thirteenth aspect, alone or in combination with one or more of the first through twelfth aspects, the component includes a sensor.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 140. The communication manager 140 may include one or more of a detection component 808, an antenna switching component 810, and/or a measurement component 812, among other examples.

In some aspects, the apparatus 800 may be configured to perform one or more operations described herein in connection with FIGS. 6A-6G. Additionally, or alternatively, the apparatus 800 may be configured to perform one or more processes described herein, such as process 700 of FIG. 7, or a combination thereof. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The reception component 802 and/or the transmission component 804 may communicate using a first antenna and a second antenna, wherein a number of receiving RF chains associated with the apparatus 800 is less than a number of physical antennas, including the first antenna and the second antenna, associated with the apparatus 800. The detection component 808 may detect an event associated with a component of the UE, wherein the event is associated with antenna switching and with the first antenna. The antenna switching component 810 may switch an RF chain from the first antenna to a third antenna based at least in part on the detection of the event and the event being associated with the first antenna. The measurement component 812 may measure, using the second antenna and the third antenna, one or more signals to obtain one or more measurement values based at least in part on switching the RF chain from the first antenna to the third antenna. The transmission component 804 may transmit a communication using the second antenna or the third antenna based at least in part on the one or more measurement values.

The transmission component 804 may transmit the communication using an antenna, from the second antenna and the third antenna, that is associated with higher measurement values from the first one or more measurement values and the second one or more measurement values.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a user equipment (UE), comprising: communicating using a first antenna and a second antenna, wherein a number of receiving radio frequency (RF) chains associated with the UE is less than a number of physical antennas, including the first antenna and the second antenna, associated with the UE; detecting an event associated with a component of the UE, wherein the event is associated with antenna switching and with the first antenna; switching an RF chain from the first antenna to a third antenna based at least in part on the detection of the event and the event being associated with the first antenna; measuring, using the second antenna and the third antenna, one or more signals to obtain one or more measurement values based at least in part on switching the RF chain from the first antenna to the third antenna; and transmitting a communication using the second antenna or the third antenna based at least in part on the one or more measurement values.

Aspect 2: The method of Aspect 1, wherein the UE is associated with at least a first group of antennas and a second group of antennas, wherein the first group of antennas includes a first one or more antennas, from the first antenna, the second antenna, and the third antenna, that are associated with a first physical area of the UE, and wherein the second group of antennas includes a second one or more antennas, from the first antenna, the second antenna, and the third antenna, that are associated with a second physical area of the UE.

Aspect 3: The method of Aspect 2, wherein the first antenna is included in the first group of antennas, wherein the event is associated with the first group of antennas, and wherein switching the RF chain from the first antenna to the third antenna is based at least in part on the event being associated with the first group of antennas.

Aspect 4: The method of any of Aspects 2-3, wherein the first antenna is included in the first group of antennas, wherein the event is associated with the first group of antennas and with switching the first antenna to another antenna included in the first group of antennas, and wherein switching the RF chain from the first antenna to the third antenna is based at least in part on the third antenna being included in the first group of antennas.

Aspect 5: The method of Aspect 2, wherein the first antenna is included in the first group of antennas, wherein the event is associated with the first group of antennas and with switching the first antenna to an antenna included in a group other than the first group of antennas, and wherein switching the RF chain from the first antenna to the third antenna is based at least in part on the third antenna being included in the second group of antennas.

Aspect 6: The method of any of Aspects 2-5, wherein the first antenna is included in the first group of antennas, wherein the event is associate with the first group of antennas not being used based at least in part on the detection of the event, and wherein switching the RF chain from the first antenna to the third antenna is based at least in part on the third antenna not being included in the first group of antennas.

Aspect 7: The method of any of Aspects 1-6, wherein the event is associated with the first antenna being unavailable based at least in part on the detection of the event.

Aspect 8: The method of any of Aspects 1-7, wherein switching the RF chain from the first antenna to the third antenna is based at least in part on the first antenna being associated with a transmitting RF chain prior to the detection of the event.

Aspect 9: The method of any of Aspects 1-8, wherein switching the RF chain from the first antenna to the third antenna is based at least in part on the event being associated with the first antenna.

Aspect 10: The method of any of Aspects 1-9, the one or more measurement values include a first one or more measurement values associated with the second antenna and a second one or more measurement values associated with the third antenna, and wherein transmitting the communication using the second antenna or the third antenna comprises: transmitting the communication using an antenna, from the second antenna and the third antenna, that is associated with higher measurement values from the first one or more measurement values and the second one or more measurement values.

Aspect 11: The method of any of Aspects 1-10, wherein the detection of the event comprises detecting that the component is active.

Aspect 12: The method of any of Aspects 1-11, wherein the component includes a charging port.

Aspect 13: The method of any of Aspects 1-12, wherein the component includes a camera.

Aspect 14: The method of any of Aspects 1-13, wherein the component includes a sensor.

Aspect 15: An apparatus for wireless communication at a device, comprising a processor; memory coupled with the processor; and instructions stored in the memory and executable by the processor to cause the apparatus to perform the method of one or more of Aspects 1-14.

Aspect 16: A device for wireless communication, comprising a memory and one or more processors coupled to the memory, the one or more processors configured to perform the method of one or more of Aspects 1-14.

Aspect 17: An apparatus for wireless communication, comprising at least one means for performing the method of one or more of Aspects 1-14.

Aspect 18: A non-transitory computer-readable medium storing code for wireless communication, the code comprising instructions executable by a processor to perform the method of one or more of Aspects 1-14.

Aspect 19: A non-transitory computer-readable medium storing a set of instructions for wireless communication, the set of instructions comprising one or more instructions that, when executed by one or more processors of a device, cause the device to perform the method of one or more of Aspects 1-14.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
communicating using a first antenna and a second antenna, wherein a number of receiving radio frequency (RF) chains associated with the UE is less than a number of physical antennas, including the first antenna and the second antenna, associated with the UE;
detecting an event associated with a component of the UE, wherein the event is associated with antenna switching and with the first antenna;
switching an RF chain from the first antenna to a third antenna based at least in part on the detection of the event and the event being associated with the first antenna;
measuring, using the second antenna and the third antenna, one or more signals to obtain one or more measurement values based at least in part on switching the RF chain from the first antenna to the third antenna; and
transmitting a communication using the second antenna or the third antenna based at least in part on the one or more measurement values.

2. The method of claim 1, wherein the UE is associated with at least a first group of antennas and a second group of antennas,
wherein the first group of antennas includes a first one or more antennas, from the first antenna, the second antenna, and the third antenna, that are associated with a first physical area of the UE, and
wherein the second group of antennas includes a second one or more antennas, from the first antenna, the second antenna, and the third antenna, that are associated with a second physical area of the UE.

3. The method of claim 2, wherein the first antenna is included in the first group of antennas,
wherein the event is associated with the first group of antennas, and
wherein switching the RF chain from the first antenna to the third antenna is based at least in part on the event being associated with the first group of antennas.

4. The method of claim 2, wherein the first antenna is included in the first group of antennas,
wherein the event is associated with the first group of antennas and with switching the first antenna to another antenna included in the first group of antennas, and
wherein switching the RF chain from the first antenna to the third antenna is based at least in part on the third antenna being included in the first group of antennas.

5. The method of claim 2, wherein the first antenna is included in the first group of antennas,
wherein the event is associated with the first group of antennas and with switching the first antenna to an antenna included in a group other than the first group of antennas, and
wherein switching the RF chain from the first antenna to the third antenna is based at least in part on the third antenna being included in the second group of antennas.

6. The method of claim 2, wherein the first antenna is included in the first group of antennas,
wherein the event is associated with the first group of antennas not being used based at least in part on the detection of the event, and
wherein switching the RF chain from the first antenna to the third antenna is based at least in part on the third antenna not being included in the first group of antennas.

7. The method of claim 1, wherein the event is associated with the first antenna being unavailable based at least in part on the detection of the event.

8. The method of claim 1, wherein switching the RF chain from the first antenna to the third antenna is based at least in part on the first antenna being associated with a transmitting RF chain prior to the detection of the event.

9. The method of claim 1, wherein switching the RF chain from the first antenna to the third antenna is based at least in part on the event being associated with the first antenna.

10. The method of claim 1, wherein the one or more measurement values include a first one or more measurement values associated with the second antenna and a second one or more measurement values associated with the third antenna, and wherein transmitting the communication using the second antenna or the third antenna comprises:
transmitting the communication using an antenna, from the second antenna and the third antenna, that is associated with higher measurement values from the first one or more measurement values and the second one or more measurement values.

11. The method of claim 1, wherein the detection of the event comprises detecting that the component is active.

12. The method of claim 1, wherein the component includes a camera.

13. A user equipment (UE) for wireless communication, comprising:
a memory; and
one or more processors, coupled to the memory, configured to:
communicate using a first antenna and a second antenna, wherein a number of receiving radio frequency (RF) chains associated with the UE is less than a number of physical antennas, including the first antenna and the second antenna, associated with the UE;
detect an event associated with a component of the UE, wherein the event is associated with antenna switching and with the first antenna;
switch an RF chain from the first antenna to a third antenna based at least in part on the detection of the event and the event being associated with the first antenna;
measure, using the second antenna and the third antenna, one or more signals to obtain one or more measurement values based at least in part on switching the RF chain from the first antenna to the third antenna; and
transmit a communication using the second antenna or the third antenna based at least in part on the one or more measurement values.

14. The UE of claim 13, wherein the UE is associated with at least a first group of antennas and a second group of antennas,
wherein the first group of antennas includes a first one or more antennas, from the first antenna, the second antenna, and the third antenna, that are associated with a first physical area of the UE, and
wherein the second group of antennas includes a second one or more antennas, from the first antenna, the second antenna, and the third antenna, that are associated with a second physical area of the UE.

15. The UE of claim 14, wherein the first antenna is included in the first group of antennas,
wherein the event is associated with the first group of antennas, and
wherein switching the RF chain from the first antenna to the third antenna is based at least in part on the event being associated with the first group of antennas.

16. The UE of claim 14, wherein the first antenna is included in the first group of antennas,
wherein the event is associated with the first group of antennas and with switching the first antenna to another antenna included in the first group of antennas, and
wherein switching the RF chain from the first antenna to the third antenna is based at least in part on the third antenna being included in the first group of antennas.

17. The UE of claim 14, wherein the first antenna is included in the first group of antennas,
wherein the event is associated with the first group of antennas and with switching the first antenna to an antenna included in a group other than the first group of antennas, and
wherein switching the RF chain from the first antenna to the third antenna is based at least in part on the third antenna being included in the second group of antennas.

18. The UE of claim 14, wherein the first antenna is included in the first group of antennas,
wherein the event is associated with the first group of antennas not being used based at least in part on the detection of the event, and
wherein switching the RF chain from the first antenna to the third antenna is based at least in part on the third antenna not being included in the first group of antennas.

19. The UE of claim 13, wherein the event is associated with the first antenna being unavailable based at least in part on the detection of the event.

20. The UE of claim 13, wherein switching the RF chain from the first antenna to the third antenna is based at least in part on the first antenna being associated with a transmitting RF chain prior to the detection of the event.

21. The UE of claim 13, wherein the one or more measurement values include a first one or more measurement values associated with the second antenna and a second one or more measurement values associated with the third antenna, and wherein the one or more processors, to transmit the communication using the second antenna or the third antenna, are configured to:
transmit the communication using an antenna, from the second antenna and the third antenna, that is associated with higher measurement values from the first one or more measurement values and the second one or more measurement values.

22. The UE of claim 13, wherein the one or more processors, to detect the event, are configured to detect that the component is active.

23. The UE of claim 13, wherein the component includes at least one of:
a charging port,
a camera, or
a sensor.

24. A non-transitory computer-readable medium storing a set of instructions for wireless communication, the set of instructions comprising:
one or more instructions that, when executed by one or more processors of a user equipment (UE), cause the UE to:
communicate using a first antenna and a second antenna, wherein a number of receiving radio frequency (RF) chains associated with the UE is less than a number of physical antennas, including the first antenna and the second antenna, associated with the UE;
detect an event associated with a component of the UE, wherein the event is associated with antenna switching and with the first antenna;
switch an RF chain from the first antenna to a third antenna based at least in part on the detection of the event and the event being associated with the first antenna;
measure, using the second antenna and the third antenna, one or more signals to obtain one or more measurement values based at least in part on switching the RF chain from the first antenna to the third antenna; and
transmit a communication using the second antenna or the third antenna based at least in part on the one or more measurement values.

25. The non-transitory computer-readable medium of claim 24, wherein the event is associated with the first antenna being unavailable based at least in part on the detection of the event.

26. The non-transitory computer-readable medium of claim 24, wherein switching the RF chain from the first antenna to the third antenna is based at least in part on the first antenna being associated with a transmitting RF chain prior to the detection of the event.

27. An apparatus for wireless communication, comprising:
means for communicating using a first antenna and a second antenna, wherein a number of receiving radio frequency (RF) chains associated with the apparatus is less than a number of physical antennas, including the first antenna and the second antenna, associated with the apparatus;
means for detecting an event associated with a component of the apparatus, wherein the event is associated with antenna switching and with the first antenna;
means for switching an RF chain from the first antenna to a third antenna based at least in part on the detection of the event and the event being associated with the first antenna;
means for measuring, using the second antenna and the third antenna, one or more signals to obtain one or more measurement values based at least in part on switching the RF chain from the first antenna to the third antenna; and
means for transmitting a communication using the second antenna or the third antenna based at least in part on the one or more measurement values.

28. The apparatus of claim 27, wherein the apparatus is associated with at least a first group of antennas and a second group of antennas,
wherein the first group of antennas includes a first one or more antennas, from the first antenna, the second antenna, and the third antenna, that are associated with a first physical area of the apparatus, and
wherein the second group of antennas includes a second one or more antennas, from the first antenna, the second antenna, and the third antenna, that are associated with a second physical area of the apparatus.

29. The apparatus of claim 28, wherein the first antenna is included in the first group of antennas,
wherein the event is associated with the first group of antennas, and
wherein the means for switching the RF chain from the first antenna to the third antenna comprise means for switching the RF chain based at least in part on the event being associated with the first group of antennas.

30. The apparatus of claim 28, wherein the first antenna is included in the first group of antennas,
wherein the event is associated with the first group of antennas and with switching the first antenna to another antenna included in the first group of antennas, and
wherein the means for switching the RF chain from the first antenna to the third antenna comprise means for switching the RF chain from the first antenna to the third antenna based at least in part on the third antenna being included in the first group of antennas.
